(19) United States
(12) Patent Application Publication
(10) Pub. No.: US 2024/0371285 A1
(43) Pub. Date: Nov. 7, 2024

(54) SYSTEM AND METHOD FOR MANAGING RECALL ACTIVITIES WITH EXTENDED REALITY

(71) Applicant: Chegg, Inc., Santa Clara, CA (US)

(72) Inventor: Vincent LE CHEVALIER, Waikoloa, HI (US)

(21) Appl. No.: 18/310,257

(22) Filed: May 1, 2023

(51) Int. Cl. G09B 5/02; G06F 3/01; G06F 3/16; G06T 19/00

(52) U.S. Cl. CPC G09B 5/02; G06F 3/017; G06F 3/167; G06T 19/006

(57) ABSTRACT

Methods, systems, and apparatus, including computer programs encoded on computer storage media, for managing recall activities. One of the methods includes receiving, from a server, recall content associated with a recall activity session for provision to a user; generating a digital watermark based on information associated with the recall activity session; rendering the recall content to the user in a virtual field of view, wherein the digital watermark is embedded into the rendered recall content; capturing an answer to the recall content based on one or more activities of the user in a physical environment, the one or more activities being responsive to the rendering of the recall content; rendering the captured answer in the virtual field of view; and sending, to the server, data associated with the captured answer.

### TECHNICAL FIELD

This application generally relates to automatically rendering recall content to a user and capturing answers from the user using an extended-reality device.

### BACKGROUND

Online education platforms enable a student to access various educational content and engage in various learning activities through personal computing devices and Internet connections. The online learning activities include, for example, reading text-based books and notes, consuming multimedia content such as lectures, communicating in real time with instructors, and taking tests and examinations, etc.

Recall activities such as tests and examinations are often used in educational and professional settings to assess the knowledge, skills, or abilities of individuals based on their answers to questions. Question-and-answer activities also occur in other social settings in formats such as surveys (e.g., research, census), forms (e.g., elections, application), and questionnaires (e.g., feedback, information collection). The delivery of questions and collection of answers can be carried out in various ways, such as on paper, spoken, or digitally over the internet. Under current approaches, the questions and answers are typically presented using the same medium. As an example, for a written test, a test paper may include multiple questions and the student may directly write the answers to the questions on the paper. As another example, a student may access an online test from her personal computer. The student may read the questions on a screen of the personal computer and type in answers for display on the same screen. The presentation of questions and answers using the same medium makes it possible for an unauthorized person to copy or share the test content. This may lead to misuse of the test content and academic misconduct. Human proctoring or monitoring is often required to prevent such misuse. Recall activities are often subject to limitations such as the location or time for each such activity.

### SUMMARY

Various embodiments of the specification include, but are not limited to, systems, methods, and non-transitory computer readable media for managing recall activities with extended reality.

According to one embodiment, an extended-reality system for managing recall activities, comprising one or more processors and a non-transitory computer readable medium storing instructions that, when executed by the one or more processors, cause the system to perform operations. The operations comprise receiving, from a server, recall content associated with a recall activity session for provision to a user; generating a digital watermark based on information associated with the recall activity session; rendering the recall content to the user in a virtual field of view, wherein the digital watermark is embedded into the rendered recall content; capturing an answer to the recall content based on one or more activities of the user in a physical environment, the one or more activities being responsive to the rendering of the recall content; rendering the captured answer in the virtual field of view; and sending, to the server, data associated with the captured answer.

In some embodiments, the capturing an answer to the recall content comprises capturing one or more images of the user writing on a physical or digital medium in the physical environment; performing automatic pattern recognition on the one or more images to determine content written by the user; and setting the answer as the content written by the user.

In some embodiments, the capturing an answer to the recall content comprises capturing one or more images of a hand gesture of the user in the physical environment; determining a location in the virtual field of view that corresponds to the hand gesture of the user in the one or more captured images; and determining the answer based on the determined location and the hand gesture of the user.

In some embodiments, the capturing an answer to the recall content comprises capturing one or more images of the user's hand gestures in the physical environment; determining one or more characters traced by the user by tracking movement of the user's hand gestures based on the one or more images; generating, using an autocomplete algorithm, one or more words based on the one or more determined characters; and generating the answer as including the one or more generated words.

In some embodiments, the capturing an answer to the recall content comprises capturing an audio record of the user speaking; and determining the answer by processing the audio record using a speech-recognition algorithm.

In some embodiments, the digital watermark comprises one or more of identification information of the recall content; ownership information of the recall content; identification information of the user; time information of the recall activity session; and identification information of the extended-reality system.

In some embodiments, the operations further comprise automatically selecting an input method based on a type of question associated with the recall content, wherein the capturing the answer comprises analyzing the one or more activities of the user based on the selected input method.

In some embodiments, the rendering the recall content to the user in a virtual field of view comprises rendering the recall content constructively to overlay on a visual representation of the physical environment or rendering the recall content destructively to mask at least part of the visual representation of the physical environment. The operations further comprise determining whether to render the recall content constructively or destructively based on the selected input method.

In some embodiments, the recall activity session is associated with a plurality of pieces of recall content. The receiving the recall content comprises receiving a first piece of recall content, wherein the first piece of recall content is encrypted by a first set of digital rights management (DRM) credentials. The operations further comprise receiving, from the server, a second piece of recall content associated with the recall activity session, wherein the second piece of recall content is encrypted by a second set of DRM credentials.

In some embodiments, the data associated with the captured answer comprise content of the captured answer; and a real-time data log associated with the captured answer.

According to another embodiment, a method for managing recall activities implemented on an extended-reality device comprises receiving, from a server, recall content associated with a recall activity session for provision to a user; generating a digital watermark based on information associated with the recall activity session; rendering the recall content to the user in a virtual field of view, wherein the digital watermark is embedded into the rendered recall content; capturing an answer to the recall content based on one or more activities of the user in a physical environment, the one or more activities being responsive to the rendering of the recall content; rendering the captured answer in the virtual field of view; and sending, to the server, data associated with the captured answer.

According to yet another embodiment, a non-transitory computer-readable storage medium associated with an extended-reality device for managing recall activities is configured with instructions executable by one or more processors to cause the one or more processors to perform operations. The operations comprise receiving, from a server, recall content associated with a recall activity session for provision to a user; generating a digital watermark based on information associated with the recall activity session; rendering the recall content to the user in a virtual field of view, wherein the digital watermark is embedded into the rendered recall content; capturing an answer to the recall content based on one or more activities of the user in a physical environment, the one or more activities being responsive to the rendering of the recall content; rendering the captured answer in the virtual field of view; and sending, to the server, data associated with the captured answer.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as limiting.

### BRIEF DESCRIPTION OF THE DRAWINGS

FIG. 1 illustrates an example network environment for managing recall activities with extended reality.

FIG. 2 illustrates an example system and process for creating a digital watermark for recall content.

FIG. 3 illustrates an example interface for presenting recall content to a user and capturing an answer to the recall content based on pattern recognition.

FIG. 4 illustrates an example interface for presenting recall content to a user and capturing an answer to the recall content based on gesture recognition.

FIG. 5 illustrates an example extended-reality-based autocomplete process for capturing an answer.

FIG. 6 illustrates an example interface for presenting recall content to a user and capturing an answer to the recall content based on gesture-based character tracing.

FIG. 7 illustrates an example speech recognition process for capturing an answer.

FIG. 8 illustrates an example interface for presenting recall content to a user and capturing an answer to the recall content based on audio input.

FIG. 9 illustrates an example process for managing recall activities using a server-client system.

FIG. 10 illustrates an example method for managing recall activities using an extended-reality device.

FIG. 11 illustrates a block diagram of a computer system in which any of the embodiments described herein may be implemented.

### DETAILED DESCRIPTION

Embodiments disclosed herein provide methods and systems for generating recall content and managing recall activity services to students and professionals wearing extended-reality devices, such as connected glasses or headsets. The embodiments leverage features of extended-reality devices including the ability to blend real and virtual worlds for display to a user, real-time multimedia interactions with the user, and accurate three-dimensional registration of virtual and real objects as well as the user's movements. The extended-reality device may provide a virtual field of view to the user, in which a real or virtual environment may be displayed, and sensory content may be overlaid on the environment in a constructive (i.e., additive to the environment) or destructive (i.e., masking of the environment) manner. According to some embodiments, the extended-reality device may render the recall content privately into its built-in display before capturing an answer provided from the user's actions in the physical world by using its built-in sensors.

Embodiments disclosed herein provide features for protecting academic or professional recall content. By using an extended-reality device, the recall content is published privately to a user, one section or question at a time, watermarked by embedding the name of the user and device ID into the rendered recall content. The displayed recall content is secured because of an end-to-end connection between the extended-reality device and the back-end servers of the online education platform. The recall content is further protected because the extended-reality device is aware of the user's physical environment at all times when an answer is provided by that user. Because the questions are decoupled from the user's answers, as the two forms of content exist in different media (e.g., questions existing in the user's virtual field of view while answers detected based on the user's activities in the physical environment), the captured answers are dissociated from the questions, thus limiting the unauthorized sharing of recall question-answer content between users. In addition, a watermark may blend content element of the real and virtual worlds to further protect the recall content.

Embodiments disclosed herein may enable a user to provide answers to the recall content overlaid onto the virtual field of view using several types of media by leveraging the extended-reality device's built-in sensors to capture the user's activities. For example, an answer may be captured by applying optical character recognition (“OCR”) on handwritings on a physical medium (e.g., written text on a napkin, paper notebook, or whiteboard) or text typed or otherwise entered into a digital medium (e.g., Note/Word application running on a computer). An answer may alternatively be captured based on biometrics, such as voice entry through the extended-reality device's microphone(s). An answer may also be captured by detecting the user's hand gestures pointing to or clicking on an answer choice or tracing letters in thin air. The medium used for capturing answers may be selected either by the user or by an application running on the extended-reality device configured to provide the recall services. The selection of medium may be made before or during any recall activities, leveraging the unique capabilities of the extended-reality device for managing recall activities and services.

The embodiments disclosed herein provide various technical benefits and improvements over the state of the art. First, some embodiments present questions to users in the virtual field of view but capture answers from the real physical environment by structuring recall activities using different modes of answer capture. This facilitates the protection of recall content by separating the media used for the questions and answers and increases the difficulty of unauthorized copying and academic misconduct. Second, the embodiments allow selection from multiple modes of answer capture based on the types of questions, the nature of the recall activities, and the user's preferences. Leveraging the sensing capabilities of an extended-reality device, these features allow the flexible adaptation of answer capturing to the user's recall activities and physical environment. Third, some embodiments create watermarks for recall content based on a real-time capture of media content by the extended-reality device. Furthermore, the embodiments enable the recordation of log data using sensors of the extended-reality device and integration of the log data with the recall content. The watermark and log data facilitate the automatic detection of improper conduct during the recall activities without involvement of a human proctor. Fourth, some embodiments can be carried out on the client side with only an extended-reality device. The embodiments provide a new hands-free approach to question-and-answer activities, without requiring specific setups of, for example, desks, papers, pens, or computer display and input devices. As these embodiments allow the questions and answers to be separately presented and enable the automatic monitoring of the recall activities, the recall activities may be carried out at arbitrary locations, times, and environments. This may remove the need of, for example, requiring an examination to take place at a set time with the presence of a proctor.

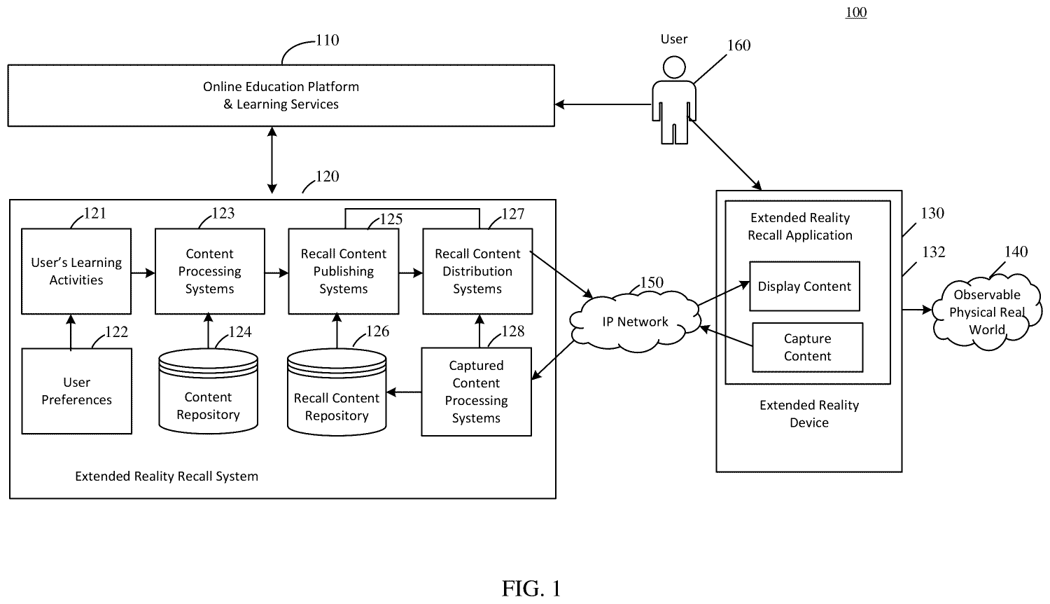

FIG. 1 illustrates an example network environment for managing recall activities with extended reality. In some embodiments, methods, apparatus, devices, and systems disclosed herein are implemented in a network environment 100 illustrated in FIG. 1. The network environment 100 may comprise an online education platform 110, an extended-reality recall system 120, an extended-reality device 130. The extended-reality device 130 may be placed in a physical environment 140 and connected to the extended-reality recall system 120 using a network 150. The extended-reality device 130 may be owned by or otherwise used by a user 160. The user 160 may access one or more services on the online education platform 110 using the extended-reality device 130 or one or more other electronic devices such as a smart phone, a personal computer, a laptop computer, a desktop computer, another suitable device, or any combination thereof. The extended-reality recall system 120 may be implemented as part of the online education platform 110, for example, as computer programs running on one or more server-side devices associated with the online education platform 110. Alternatively, the extended-reality recall system 120 may be implemented on hardware infrastructure separate from the online education platform 110 and communicate with the online education platform 110 through one or more network interfaces.

The extended-reality recall system 120 may be implemented on one or more server-side computing devices. The extended-reality recall system 120 may operate one or more modules corresponding to different aspects of managing a user's recall activities using extended reality. Each module may comprise one or more software algorithms implemented on and executed by one or more server-side devices associated with the extended-reality recall system 120.

The extended-reality recall system 120 may comprise a learning activity module 121 for accessing and managing users' learning activities on the online education platform 110. The online education platform 110 may provide various learning services to its registered users. The learning services may include passive learning services that provide content to be read, watched, or listened to by a learner, such as e-textbooks, flash cards, tutorial videos, online lectures, and white papers. No new content is created by users in passive learning activities. The learning services may also include active learning services that provide content that is made for interaction with the learner, such as question & answers, quizzes, interactive tutorials, note taking. In active learning activities, the users create content. The learning services may further include recall-type learning services that provide content used for testing the knowledge of the learner, such as tests or examinations. The tests may cover a wide range of content and skill set including, for example, SAT, DMV test, Excel skill test, IQ test, other suitable tests or examinations, or any combination thereof. Content corresponding to recall learning activities, which are referred to herein as recall content, may comprise questions, problems, and content that provide context for the questions or problems (e.g., reading material provided before questions regarding the reading material). In recall activities, the users create new content by providing answers to questions. The learning activities of a user 160 may be referred to herein as PAR (i.e., passive, active, recall) learning activities. In some embodiments, the online education platform 110 captures and records users' PAR learning activities and shares records of such activities with the extended-reality recall system 120.

In some embodiments, the learning activity module 121 may provide personalized or customizable learning content to a user 160. The learning content may be personalized or customized by one or more preferences set by the user 160 and managed by the user preferences module 122. The extended-reality recall system may provide personalized recall content to the user 160 based on the user's PAR learning activities on the online education platform 110 or the activities of users with similar student or professional profiles. For example, recall content including a series of questions may be created for a user 160 based on the subjects and topics that the user 160 learned on the online education platform 110 in a certain period of time. Further details regarding providing personalized learning content to a user 160 are described in U.S. patent application Ser. No. 13/971,738 with the title “Automated Course Deconstruction into Learning Units in Digital Education Platforms,” issued as U.S. Pat. No. 9,378,647; U.S. patent application Ser. No. 17/531,594 with the title “Correlating Jobs with Personalized Learning Activities in Online Education Platforms,” published as U.S. Patent Application Publication No. 2022/0129855; and U.S. patent application Ser. No. 14/015,674 with the title “Augmented Reading Systems,” issued as U.S. Pat. No. 9,870,358, all of which are hereby incorporated by reference.

The extended-reality recall system 120 may comprise a content processing system 123 and a content repository 124. The content processing system 123 may extract, index, identify, and correlate content to be assigned to each recall activity from one or more of a variety of content sources. Some or all of the content used by the content processing system 123 may be stored in the content repository 124. The content may comprise academic content, such as, for example, textbooks, research papers, training documents or online courses. Such content may provide background structured material which is deconstructed by the recall content publishing system 125 to extract key words, definitions, figures, references, and related content to be associated to recall activities. For example, a user 160 who just learned about the “Pythagorean Theorem” in the “Geometry” course can be subsequently tested during a recall session using recall content on the “Pythagorean Theorem.” Further details regarding content extraction and association as well as recall content generation are described in U.S. patent application Ser. No. 13/898,377 with the title “Automated Testing Materials in Electronic Document Publishing,” issued as U.S. Pat. No. 10,108,585, which is hereby incorporated by reference.

The content used by the content processing system 123 may comprise standardized tests, such as, for example, SAT or IQ test. Such content is deconstructed by a recall content publishing system 125 into sets of individual questions and distributed by a recall content distribution system 127. For example, a SAT math section typically includes 58 questions to be completed in 80 minutes max. The deconstruction process may extract each of these questions and reformat them for the recall content distribution systems 127 to send to a user's extended-reality device for rendering.

The content used by the content processing system 123 may comprise content related to job requirements. A recruiter seeking to assess candidates often requests testing based on the job requirements. The content processing system 123 may extract one or more skills from the job requirements and generate one or more questions structured base on the knowledge or skills required and the level of complexity or sophistication required. Further details on extracting recall content from deconstructed job listings are described in U.S. patent application Ser. No. 17/531,594 with the title “Correlating Jobs with Personalized Learning Activities in Online Education Platforms,” published as U.S. Patent Application Publication No. 2022/0129855, which is hereby incorporated by reference.

The content used by the content processing system 123 may comprise concept-specific content. The content processing system 123 may generate and assign concepts to every recall content items in the content repository 124 using a machine-learning model. The machine-learning model may be trained with a model trainer using an ensemble method, such as linear support vector classification, logistic regression, k-nearest neighbor, naïve Bayes, or stochastic gradient descent. As an example, for a particular chapter (e.g., Chapter 1) in a particular Textbook (e.g., Biology 101) in content repository, content processing module may assign the following concepts: process of science, macromolecules, cell, membranes, energy, enzymes, cellular respiration, and photosynthesis. In some embodiments, the content processing system 123 may identify associations between concepts. Using the identified associations, the content processing system 123 may generate concept pairs, where concepts in a concept pair are related to each other. For example, the content processing system 123 identifies associations between concepts based on a determination that two concepts frequently appear in proximity to one another in content items are likely to be related. Accordingly, the content processing system 123 may identify associations between concepts appearing in proximity to one another in the passive, active and recall content items of the content repository 124, such as concepts appearing on the same page, concepts appearing in the same section of two documents, concepts appearing in different Q&As or concepts appearing in different tests. For example, the content processing system 123 may apply an Apriori algorithm to identify concepts appearing in proximity to one another across multiple recall content items. For concepts assigned to a particular recall content item, the content processing system 123 may also generate an indicator of a relative strength of association between the concepts and the particular content item. For example, for a first concept that is very strongly associated with a particular recall document, the content processing system 123 may assign, say, a score of 0.99, while for a second concept that is only mildly associated with the particular content item, the content processing system 123 may assign a score of 0.4. The recall content publishing system 125 may publish recall content based on concepts learned by a user 160 and the association between recall content and the learned concepts.

The extended-reality recall system 120 may comprise a recall content publishing system 125. The recall content publishing system 125 may structure the types of questions and content of recall activities to be published and distributed to an extended-reality recall application 132 running on the extended-reality device 130. The recall content publishing system 125 may retrieve recall content and associations between the recall content and different concepts from the content processing system 123. The recall content publishing system 125 may publish and store recall content to a recall content repository 126, thus providing a library of available content for recall activities. Each piece of published and stored recall content may be defined by a set of properties determining is structure and publishing session criteria.

In some embodiments, recall content may be arranged in to recall activity sessions. A recall activity session may comprise a set of recall activities and corresponding content. Multiple pieces of recall content may be packaged into a single online recall activity session for provision to a user 160. The recall activity session may be defined by a plurality of properties such as a user recall profile, a type of recall activities, a type of recall questions, a number of questions for the recall activity session, and a source of the content. Properties for an example recall activity session is shown below:

| User | Type(s) | Type(s) | No. of | |
|---|---|---|---|---|
| Recall | of Recall | of Recall | Questions per | Sourced |
| Profile | Activities | Questions | Recall Session | Content |
| Student | SAT Math | Multiple | 50 Multiple | Deconstructed |
| | | Choice | Choice | SAT Math |
| | | Grid-in | 8 Grid-ins | |

The user recall profile may define an identity of the user 160 (e.g., student, professional, job seeker) and link to prior learning activities of the user 160 on the online education platform 110. The recall content publishing system 125 may determine a scope of recall content for a recall activity session based on the user's prior learning activities on the online education platform 110. In some embodiments, the recall content can be selected based on the user's prior passive and active activities, or based on specific courses, upcoming assignments, tests or as set by the user 160 for self-training. For example, a student who just learned about the “Pythagorean Theorem” in the “Geometry” Course can be subsequently tested during a recall session using recall content on the “Pythagorean Theorem.” As another example, a Professional who is upskilling, or preparing for a job interview, can access several recall content activities to refresh acquired skills, learn new ones, or be tested for skills comprehension.

The type of recall activities may be selected from a plurality of options including, for example, standardized tests, job-specific tests, and concept-specific tests. The online education platform 110 may have various questions for standardized tests (e.g., SAT, IQ test) available. The recall content publishing system 125 may deconstruct such content from the online education platform 110 into a set of individual questions and reformat the questions for distribution by the recall content distribution system 127. For example, the SAT math section typically includes 58 questions to be completed in 80 minutes. The deconstruction process may extract each of these questions and reformat them for the recall content distribution system 127 to send them to the user's extended-reality device 130 for rendering. When the type of recall activities is job-specific tests, listed job requirements may be analyzed to determine knowledge or skills required. A set of job-specific recall content may be selected based on the required knowledge or skills and packaged into individual questions that are distributed by the recall content distribution system 127 to the user's extended-reality device for rendering. The user's answer may be captured, validated, and shared with the recruiter or hiring manager that posted the job requirements. When the type of recall activities is concept-specific tests, a user 160 may be tested automatically on any single learned concept by having the recall content publishing system 127 select a set of recall content associated with that concept. In some embodiments, the extended-reality recall system 120 continuously presents the user recall content based on ongoing learning activities, such as education, training, or upskilling. The recall content may be automatically identified based on associations between concepts and recall content provided by the content processing system 123. For instance, any course can be expressed as a summation of concepts that a learner learns through passive and active activities before being tested for overall comprehension. The extended-reality-based recall testing can be accessed as soon as a new concept gets learned and/or at any point during the course for the testing of one or several concepts.

The recall content may include questions, each of which may include a sentence that seeks an answer for information collection, tests, and research. Questions have over the years evolved to different types to collect various sets of information. The type of recall questions may be selected from a plurality of options. Example types of recall questions are listed below:
Dichotomous Questions: a dichotomous question may be a “Yes/No” closed ended question used for simple validation.
Multiple Choice Questions: a multiple-choice question may include an incomplete stem (question), right answer or answers, incorrect answers, close alternatives, and distractors. A respondent may have to select one (single multiple-choice question) or multiple (multi-select multiple choice question) responses from a given list of options.
Grid-In Questions: A grid-in question is also known as a student-produced response question. It may require the respondent to come up with the answer using a grid.
Rank Order Scaling Questions: a rank order scaling question requires a respondent to rank preferences in a question in the order of choice.
Text Slider Questions: a text-slider question is a rating-scale question type that uses an interactive slider in answer to select the most appropriate option.
Constant Sum Questions: a constant sum question is also a rank order question where the respondents can only select options in the form of numeric.
Open-Ended Questions and Text Questions: A open-ended question or text question may provide a text format comment box that the respondent uses to answer based on the respondent's knowledge.
Matrix Table Questions: a matrix table question may be arranged in tabular format with questions listed on the left of the table while the answer options are at the top of the table.
Image Questions: an image question may require a respondent to click on images in order to answer the question.
Interactive Map Questions: an interactive map question may require a respondent to click on a location within a map to answer the question.
Other Types of Questions: Net Promoter Score questions, Star Rating questions, etc.

Each recall activity session may have one type of questions or multiple types of questions. For example, a recall activity session directed to SAT math may include both multiple choice questions and grid-in questions.

The number of recall questions for a recall activity session may depend on the type of recall questions selected for the user 160. The total number of questions may be defined based on the duration of the recall activity session or based on the types of recall activities, other suitable criteria, or any combination thereof. For example, an SAT math recall activity session may include 50 multiple-choice questions and 8 grid-in Questions in 80 minutes.

The source of the recall content property may indicate the source or original of the content provided to the user 160. The sources may include, for example, 3^{rd} party licensed content, recruiting entity, or automatically generated by the online education platform 110.

The recall content publishing system 125 may structure recall content based on a pre-set format. The properties for the format of recall content may be based on system settings, user preferences, properties of the extended-reality device 130 of the user 160, other suitable parameters, or any combination thereof. The structured recall content may comprise multiple components, such as digital rights management (“DRM”) information, a watermark, a timer per session, a timer per question, a mode of answer capturing method, other suitable components, or any combinations thereof. A set of properties for an example recall activity session is shown below:

| | | Timer | Timer | Answer |
|---|---|---|---|---|
| | | per | per | Capture |
| DRM | Watermark | Session | Question | Mode |
| Yes. Applied | Yes. Generated | 80 | N/A | User selection |
| to full recall | per question | minutes. | | among 4 |
| activity | rendered on | | | choices. |
| session. | extended-reality | | | |
| | application. | | | |

The recall content publishing system 125 may use one or more digital rights management (“DRM”) techniques to encrypt the recall content. Decryption credentials may be provided by the extended-reality device 130 for decrypting the recall content. As an example, the recall content publishing system 125 may use a public key to encrypt the recall content. The extended-reality device 130 may possess the private key for decrypting the recall content. DRM layers may be applied on all content for the entire recall activity session or be applied to limited portions of the recall content.

The recall content may further be embedded with one or more digital watermarks. In some embodiments, a digital watermark may be generated and embedded into the recall content at the recall content publishing system 125. In some embodiments, a digital watermark may be generated and embedded into the recall content by the extended reality device 130. In some embodiments, a digital watermark may be embedded into the recall content at each point of distribution. For example, the recall content may include a first digital watermark at the recall content publishing system 125. After the recall content is transmitted to the extended-reality device 130 by the recall content distribution system 127, the extended-reality device 130 may create a new digital watermark locally and embedded it into the recall content. This may ensure that, if a copy of the recall content is found later, the watermark can be retrieved from the copy and the source of the distribution is known. This technique may be used to detect the source of illegally copied recall content.

In some embodiments, the digital watermark may identify details of the recall activity session. The digital watermark may include information such as identification information of the recall content (e.g., filename, content ID), ownership information of the recall content (e.g., identity of owner, copyright information), identification information of the user 160 (e.g., user ID), time information of the recall activity session (e.g., session day or time), and identification information of the extended-reality device 130 (e.g., device ID). The extended-reality device 130 may render the watermark as overlap on top of the recall content.

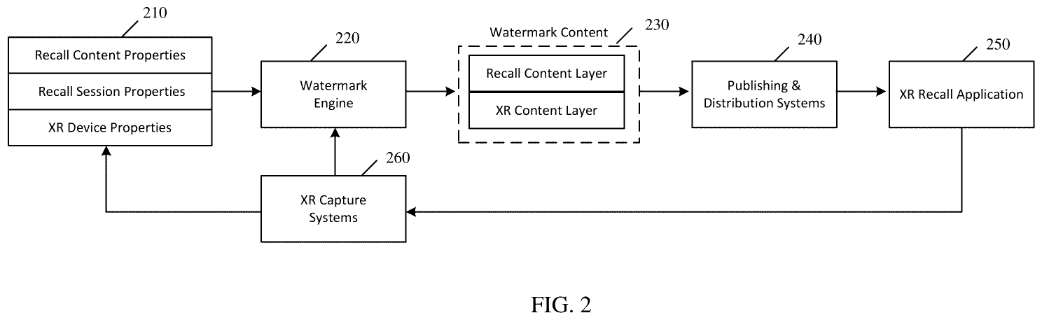

FIG. 2 illustrates an example system and process for creating a digital watermark for recall content. In some embodiments, a watermark engine 220 may collect information 210 regarding the recall activity session as described above. The collected information 210 may include, for example, recall content properties, recall session properties, extended-reality device properties. The information 210 may be collected from the online education platform 110, from the extended-reality recall application 250 running on the extended-reality device 130 through an extended-reality capture system 260, or a combination of both sources. The extended-reality recall application 250 may be implemented as the extended-reality recall application 132 in FIG. 1. For example, the recall content properties may be collected from the online education platform 110. The recall session properties and extended-reality device properties may be collected from the extended-reality device 130. The watermark engine 220 may additionally receive media content captured by the extended-reality device 130 from the extended-reality recall application 250 through the extended-reality capture system 260. The media content may include, for example, images or video captured by one or more sensor devices on the extended-reality device 130. The watermark engine 220 may generate the watermark content 230. The watermark content 230 may include two layers-a recall content layer including the information 210 collected by the watermark engine and an extended-reality content layer including the media content captured by the extended-reality device 130. This two-layer structure of the digital watermark is a unique feature of this disclosure enabled by the capabilities of an extended-reality device 130. The watermark content 230 may be transmitted to the publishing and distribution system 240. In some embodiments, the publishing and distribution system 240 may be implemented as the recall content publishing system 125 and the recall content distribution system 127. The publishing and distribution system 240 may embedded the watermark content into the recall content and distribute the combined content to the extended-reality device 130 for rendering by the extended-reality recall application 250.

While FIG. 2 illustrates an embodiment where the digital watermark 230 is generated on the server-side. This specification contemplates embodiments where the digital watermark 230 is generated on the client-side, for example, at an extended-reality device 130. For example, the watermark engine 220 and the extended-reality system 260, or their functional equivalents, may be implemented as part of the extended-reality device 130. The watermark engine 220 may collect at least part of the information 210 from the online education platform 110. The watermark content 230 may be generated locally at the extended-reality device 130 and directly rendered for display to the user 160 by the extended-reality recall application 250.

Returning to the discussion of the recall content publishing system 125, the structured recall content may further include one or more times, such as a timer for the recall activity session and a timer for each question. For example, the SAT math test is set at 80 minutes, at which point the session terminates even if the last question has not been answered by the user 160. Depending on the type of recall activities, a timer per question may also be provided to define the maximum amount of time allowed to answer a particular question by the user 160.

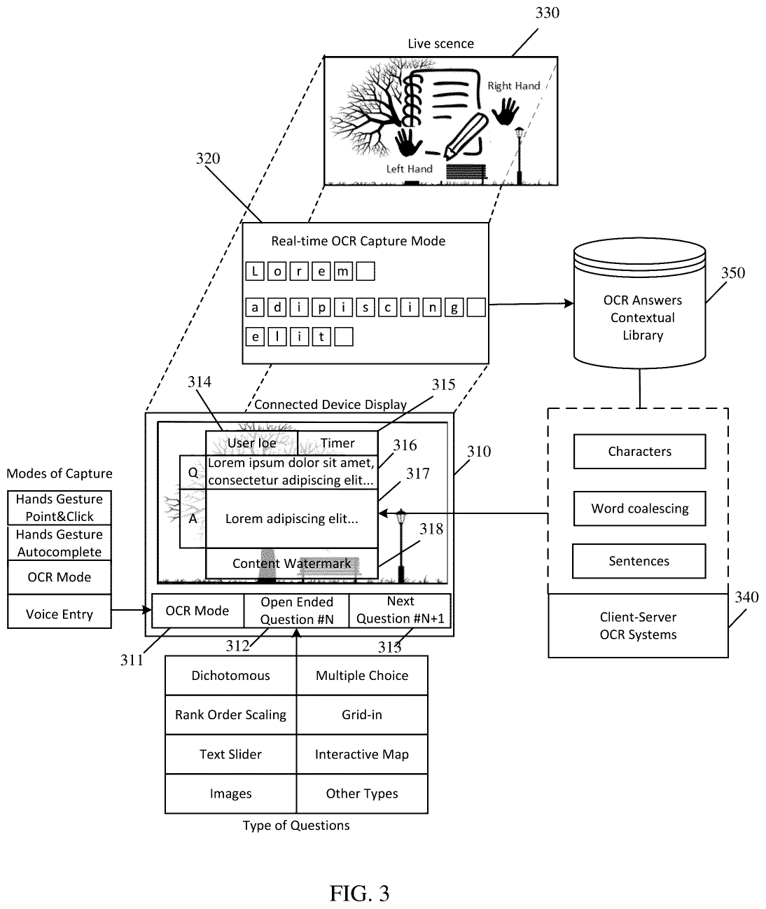

The structured recall content may further comprise a description of an answer capture mode. This may define one or more methods used by the extended-reality device 130 to capture answers from a user 160. Further details regarding the answer capture modes are described below with respect to FIGS. 3-8.

The extended-reality recall system 120 may comprise a recall content distribution system 127. The recall content distribution system 127 may transmit recall content generated by the recall content publishing system 125 to the extended-reality device 130. The recall content distribution system 127 may implement one or more techniques to protect the recall content from illegal copying or leakage. In some embodiments, the recall content distribution system 127 may transmit recall content associated with a recall activity session to the extended-reality device 130 in multiple parts. For example, when the recall activity session includes multiple questions, the recall content distribution system 127 may transmit recall content question-by-question. After transmitting each question, the recall content distribution system 127 determine that an answer has been received from the user 160 before transmitting the next question.

In some embodiments, the recall content distribution system 127 may apply DRM encryption on the recall content before transmitting it to the extended-reality device 130. The inclusion of a DRM layer is explained above. In some embodiments, the DRM layer can be updated as frequently as needed (e.g., on a question-atomic level) to provide additional levels of security. In other embodiments, the recall content distribution system 127 may limit an amount of downloads by the extended-reality device 130 or provide time-sensitive URLs in guarantying a high level of content protection. Because only part of the recall content (e.g., a question) for a recall activity session is downloadable at a time, the entire recall content is not downloaded and achieved locally and unauthorized copying or sharing becomes more challenging.

In some embodiments, the recall content distribution system 127 may dynamically adjust the level of security for a recall activity session. For example, the recall content distribution system 127 may decide to increase the level of protection for a recall activity session based on the profile of the user 160 requesting that recall content. As another example, with questions delivered dynamically, the recall content distribution system 127 may update the protection of single or groups of questions of a single recall activity session based on their relative importance, domain, complexity, or grading. In particular, a question, or group of questions, with proprietary content may have increased layers of content protection compared to a question with generic content. Similarly, a question inferred directly from recent user learning activities may be protected differently than a generic question. By having the recall content served dynamically and on-demand, the recall content distribution system 127 may authorize the download of one question of structured recall content at a time through time sensitive dedicated URLs which only stay valid for a few minutes, all under control of the extended-reality recall system. Further details regarding security techniques for content distribution are described in U.S. patent application Ser. No. 13/339,980 with the title “Digital Content Distribution and Protection,” issued as U.S. Pat. No. 8,584,259, and U.S. patent application Ser. No. 13/935,150 with the title “Authenticated Access to Accredited Testing Services,” issued as U.S. Pat. No. 9,971,741, both of which are hereby incorporated by reference.

In some embodiments, the extended-reality recall system 120 may comprise a captured content processing system 128. The captured content processing system 128 may receive captured content uploaded from the extended-reality recall application 132 on the extended-reality device 130. The captured content processing system 128 may process the captured data into actionable content using modules with software capabilities such as pattern recognition (e.g., an optical character recognition (“OCR”) engine), text autocomplete (e.g., a predictive text engine), speech recognition (e.g., a speech recognition engine). The module used to process a particular captured data may be selected based on the answer capture mode used by the user 160 in entering the answer to particular recall content. The answer capture modes are described with further details for FIG. 3-8. Content received from the extended-reality recall application 132 and processed by the captured content processing system 128 may be recorded into the recall content repository 126 for automated validation and/or subsequent review by instructors or hiring managers.

While FIG. 1 illustrates that the captured content processing system 128 is implemented as part of the extended-reality recall system 120, this disclosure contemplates implementing at least of the functionality of the captured content processing system 128 on the extended-reality device 130. In some embodiments, the extended-reality recall application 132 may process captured data using a proper software capability (e.g., pattern recognition, autocomplete, speech recognition) to generate an answer input by the user 160 and send the processed answer to the captured content processing system 128.

In some embodiments, the extended-reality (XR) device 130 may comprise an augmented-reality device, a virtual-reality device, a mixed-reality device, or another suitable device configured to provide a virtual field of view to the user 160. An augmented-reality (AR) device may be an electronic device that allows a user 160 to perceive and interact with virtual objects or information overlaid onto the real world (e.g., a physical environment). The AR device may be a wearable device, such as a headset, glasses, or a helmet, or a handheld device, such as a smartphone or a tablet. The AR device may include one or more display devices, one or more cameras, sensors, and a processing unit. The display device(s) may be positioned in proximity to a user's eyes for directly projecting images into the eyes. Alternatively, the display device(s) may comprise a screen viewable by the user 160. The cameras may capture real-world images or video, which are processed by the device's software to identify and track objects in the real world. The sensors may include accelerometers, gyroscopes, and GPS sensors to track the user's movements and orientation in space. The processing unit may use the data from the cameras and sensors to render and display virtual objects or information in real-time onto the display device(s), taking into account the user's position and orientation. The AR device may also include additional features, such as microphones, speakers, haptic feedback, and input devices, to allow the user 160 to interact with the virtual objects or information.

A virtual-reality (VR) device may be an electronic device that enables a user 160 to experience a computer-generated, immersive environment. The VR device can be in the form of a headset, goggles or glasses, or a handheld device, such as a controller or smartphone. The device may include one or more display devices, one or more sensors, and a processing unit. The display device(s) may be positioned in proximity to a user's eyes for directly projecting images into the eyes. Alternatively, the display device(s) may comprise a screen viewable be the user 160. The sensors may include accelerometers, gyroscopes, and proximity sensors to track the user's movements and orientation in space. The processing unit may use the data from the sensors to create and display computer-generated images or video onto the display devices, in a way that is aligned with the user's movements and orientation. The VR device may also include additional features, such as microphones, speakers, haptic feedback, and input devices, to allow the user 160 to interact with the virtual environment. The VR device can create a variety of environments, including realistic or abstract ones.

In some embodiments, extended-reality device 130 may comprise an extended-reality recall application 132. The extended-reality recall application 132 may manage the rendering of recall content and the real-time capture of user activities in response to recall content. The recall content may be received from the recall content distribution system 127. The captured data regarding user activities and answers generated by processing the captured data may be sent to the captured content processing system 128.

The extended-reality recall application 132 may render a user interface for displaying the recall content to the user 160. As the user 160 inputs an answer to the recall content, the extended-reality recall application 132 may further render the user's activities or answer in the user interface. The content may be overlaid on a display of the real world or physical environment as captured by the extended-reality device 130. Alternatively, the content may be overlaid on a display of a virtual, immersive environment generated by the extended-reality device 130. The overlaid content may be constructive (i.e., additive to the physical or virtual environment) or destructive (i.e., masking of the physical or virtual environment). As an example, the content of a question may be rendered in a destructive mode to be most readable by the user 160. As another example, the user activities or answer may be rendered either in destructive or constructive mode based on the capture mode selected. For instance, when OCR is used to recognize the user's writing on a physical media, the answer may be displayed in the constructive mode so that the user 160 can view both the written content and the recognized answer at the same time. On the other hand, when an answer is captured based on user hand gestures pointing to answer choices, the answer may be displayed in a destructive mode so that the user 160 views a virtual pointer or hand pointing at a virtual answer. A destructive mode may be used for entering the answer using voice commands for which it is not imperative for the user 160 to see the physical environment.

Other components of user interface rendered by the extended-reality recall application 132 may be rendered either in constructive or destructive mode. These components may comprise, for example, identification information of the user 160 (e.g., name or user ID), a type of recall activity, a type of question that may be different for different questions, a water mark, one or more timers indicating time remaining for a recall activity session or a particular question, buttons for moving to the next question, revising a question, or performing other control functionalities. The watermark may be rendered in constructive mode as a transparent or semi-transparent layer. The watermark may comprise information of the recall activity session as well as a snapshot of the live scene as watched by the user 160 through the extended-reality device 130.

The extended-reality recall application 132 may allow multiple methods for capturing the answer to a question. An answer capture mode may be selected for a particular question based on the type of the question or user preferences. As a first example, the extended-reality recall application 132 may capture an answer using real-time OCR. The user 160 may write an answer to recall content on a physical or digital medium such as a napkin, a paper notebook, a whiteboard, or a tablet computer. The extended-reality recall application 132 may capture one or more images of the user's writing and apply an OCR algorithm to recognize an answer. This mode is suitable for long text answers, among other types of answers. As a second example, the extended-reality recall application 132 may render multiple answer choices for display to the user 160 and capture of the movement of the user's hands or fingers through the front camera(s) of the extended-reality device 130 for point & click operations. This mode is suitable for multiple choice questions, among others. As a third example, the extended-reality recall application 132 may capture the movement of a user's hands or fingers through the front camera(s) of the extended-reality device 130 and trace the movement of the hands or fingers to identify one or more characters for autocomplete writing operations. This mode is suitable for short text entry answers among others. As a fourth example, the extended-reality recall application 132 may use biometrics such as voice capture to recognize an answer. The voice entry may be captured using a microphone of the extended-reality device 130.

In some embodiments, the content provided by the extended-reality recall application 132 to the extended-reality recall system 120 may comprise the captured content (e.g., captured user activities, generated answers) along with a real-time data log from the recall activities. The data log may comprise, for example, timer values, answer capture method, physical environmental information, extended-reality device data, other suitable information, or any combination thereof.

While example recall activities in educational or professional settings are described herein, this disclosure further contemplates other activities such as surveys, forms, and questionnaires. A person skilled in the art would recognize that embodiments disclosed herein further enable users to engage in these other activities using extended reality. As an example, the extended-reality device 130 may render survey questions for display to a user. The user may respond to the survey questions according to at least one of the answer capture modes disclosed herein. As another example, prompts for a ballot may be rendered by the extended-reality device 130. The user may select one or more of the candidates and answer one or more questions related to the ballot by performing one or more proper activities in a physical environment, which are captured by the extended-reality device 130 for collecting the user's vote.

FIG. 3 illustrates an example interface for presenting recall content to a user and capturing an answer to the recall content based on pattern recognition. FIG. 3 illustrates a real-time OCR answer capture mode, which enables the capture of answers written by the user on any physical or digital medium using the embedded front camera(s) of the extended-reality device 130. The extended-reality recall application 132 may then perform OCR on the captured writing to create an answer input by the user.

The extended-reality device 130 may present a user interface 310 associated with the extend-reality recall application 132 to the user. The user interface 310 may be presented in a virtual field of view of the user. The user interface 310 may include an indication of answer capture mode 311, a type of question 312, a button for moving to the next question 313 indicating the number of the next question, an identifier of the user 314, a timer 315 (e.g., a count-down timer constraining the time available for entering the answer), recall content (i.e., a question) 316, an answer field 317, and a digital watermark 318. For example, the question 316 may be an open-ended question and the answer capture mode 311 may be the real-time OCR answer capture mode. If the user interacts with the button 313 or if the timer expires, the next question may be presented in the user interface 310. Questions with the same or different types, as shown in field 312, may be presented sequentially to the user. Depending on the implementation, the answer capture mode 311 can be set by the recall activity session according to settings of the extended-reality recall system 120 or the extended-reality recall application 132 or by the user using preferences. The digital watermark 318 may be a semi-transparent watermark overlaid on the user interface 310 for additional content protection. The digital watermark may serve to combine the protected content presented to the user with a portion of the live scene watched by that user, as captured by one or more cameras of the extended-reality device 130. This may provide the benefit of effectively making the unauthorized sharing of the protected content using traditional screen capture techniques impractical.

The extended-reality device 130 may capture a live scene 330 (e.g., a physical environment) of a user writing on a physical or digital medium. Example physical media include paper notebook, whiteboard, or napkin. Example digital media include software such as Notes or Word, running on any type of connected, or non-connected, device. For digital media, the user may use any suitable input device to write down the answer including, for example, a keyboard, a mouse, a stylus pen, a touch screen, other suitable input devices, or any combination thereof. As the user writes down a succession of characters as an answer to a question, the user's writing may be captured by the extended-reality device 130. The captured writing (e.g., in the form of one or more images) 320 may be analyzed using an OCR system 340 based on data in an OCR answers contextual library 340. The OCR system 340 and the OCR answers contextual library 350 may be implemented as part of the extended-reality recall application 132, the captured content processing system 128, or a combination thereof. The OCR system 340 may be configured to assemble recognized characters into words and assemble words into sentences based on pattern recognition of the user's writing and to validate the resulting text using a language speller or grammar engine. The result is a set of words and sentences rendered into the comment box associated with the open-ended answer 317 of the extended-reality recall application 132. To the extent the OCR is at least partially performed on the client side using the extended-reality recall application 132, the recognized answer is sent to the extended-reality recall system 120. To the extend the OCR is at least partially performed on the server side using the captured content processing system 128, the answer is sent to the extended-reality device 130 for rendering. The user may edit the captured content before moving on to the next question by directly editing the content on the physical or digital medium. The extended-reality recall application 132 may further provide one or more interactive elements in the user interface 310 to allow the user to directly edit the recognized answer.

This specification further contemplates capturing the user's drawing on a physical or digital medium using the extended-reality device 130, applying pattern recognition on the captured drawing using the extended-reality recall application 132 or the captured content processing system 128 to identify a drawn figure as the answer, and rendering the drawn figure in the answer field 317. Data associated with the user's input of a figure is sent from the extended-reality device 130 to the extended-reality recall system 120 for validation and review.

Because the user does not enter the answer on a medium on which the question is displayed, this answer capture mode offers added security and difficulty for unauthorized copying or sharing of the question and answer.

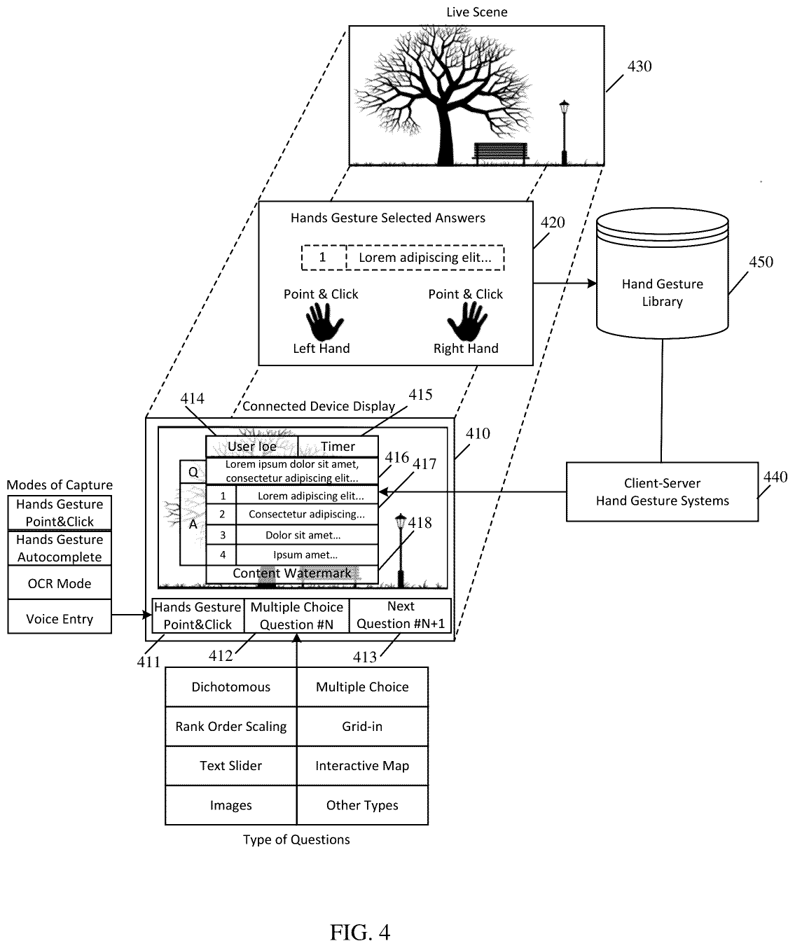

FIG. 4 illustrates an example interface for presenting recall content to a user and capturing an answer to the recall content based on gesture recognition. FIG. 3 illustrates a hand gesture Point & Click answer capture mode, which enables the capture of answers provided by the user using extended-reality “Point & Click” hand gestures captured by the embedded front camera(s) of the extended-reality device 130.

The extended-reality device 130 may present a user interface 410 associated with the extend-reality recall application 132 to the user. The user interface 410 may be presented in a virtual field of view of the user. The user interface 410 may include an indication of answer capture mode 411, a type of question 412, a button for moving to the next question 413 indicating the number of the next question, an identifier of the user 414, a timer 415 (e.g., a count-down timer constraining the time available for entering the answer), recall content (i.e., a question) 416, an answer field 417, and a digital watermark 418. For example, the question 416 may be a multiple-choice question and the answer capture mode may be the “Point & Click” mode. The extended-reality recall application 132 may have received, and decrypted if needed, the question 416 and answer options 417 from the extended-reality recall system 120 and rendered them in the user interface 410. The other components of the user interface 410 may have similar functionalities as corresponding components of the user interface 310 in FIG. 3.

The extended-reality device 130 may capture the real-time gesture of the user's hand(s) and/or finger(s) hovering next to the answer option that the user wants to select in a live scene 430 (e.g., a physical environment). The extended-reality recall application 132 may provide visualization feedback to the user, by tracking the outline of the hand(s) and/or tips of the finger(s) in real time within the virtual field of view and rendering it as a virtual cursor on top of the rendering of the question 416. To confirm the choice of answer, the user may keep hovering the virtual cursor for a small-time interval, 3 seconds for example, over the location of the selected answer, triggering a visualization and confirmation of the selection. The selection then triggers the request for the next question to be rendered. Other implementations may include different forms of confirmation gesture, such as using a straight index finger pointing, or a circle being closed between the thumb and index, for examples. The user's gesture may be analyzed using a hand gesture system 440 based on data in a hand gesture library 450, which may be developed to support the selection and confirmation of answers. The hand gesture system 440 and the hand gesture library 450 may be implemented as part of the extended-reality recall application 132, the captured content processing system 128, or a combination thereof. To the extent the hand gesture processing is at least partially performed on the client side using the extended-reality recall application 132, the recognized answer is sent to the extended-reality recall system 120. To the extend the hand gesture processing is at least partially performed on the server side using the captured content processing system 128, the answer is sent to the extended-reality device 130 for rendering. By using the Point & Click Mode, the question presented to the user and subsequent selection of an answer are only visible to that user. This shields the question and answer from people nearby, thus preventing academic misconduct. This answer capture mode also prevents unauthorized copying or sharing of the recall content.

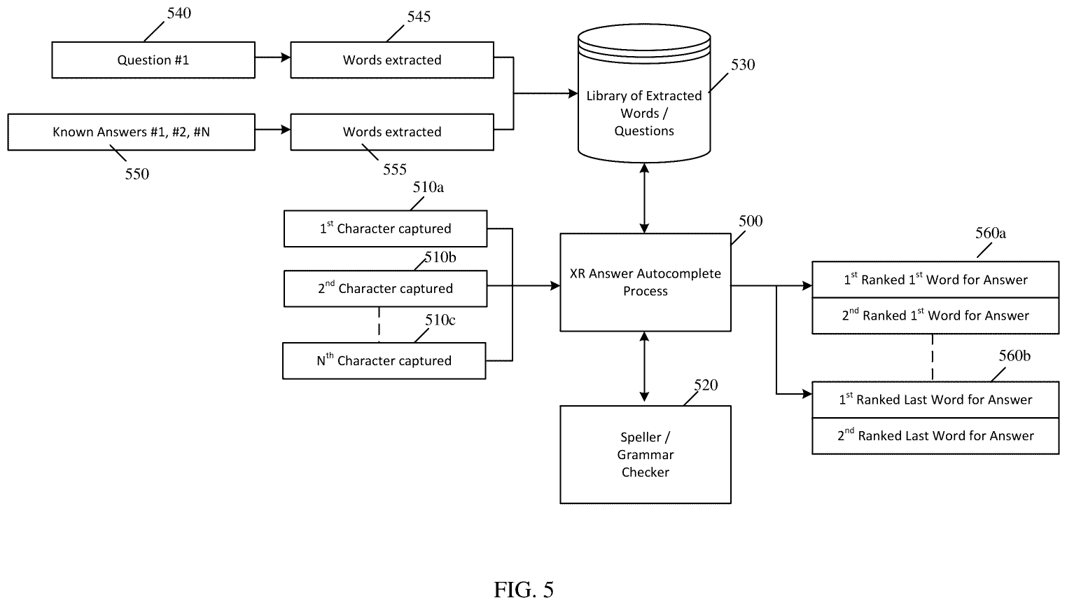

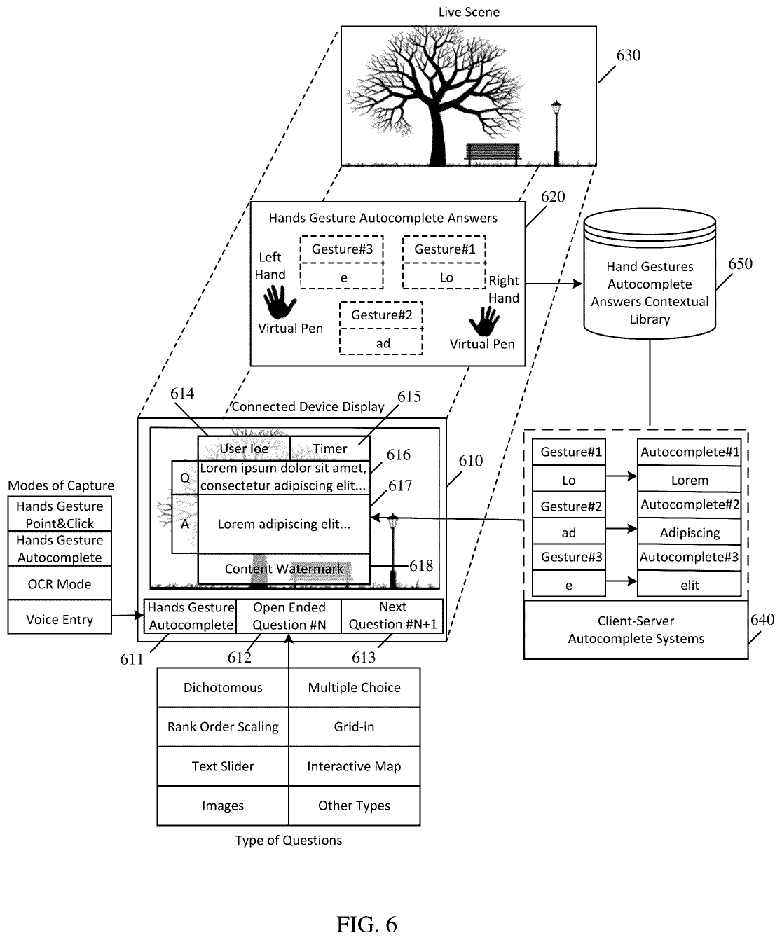

FIG. 5 illustrates an example extended-reality-based autocomplete process for capturing an answer. This process 500 may correspond to a hand gesture autocomplete answer capture mode, which enables the capture of answers provided by the user by tracing hand-gesture writings by the user as captured by the embedded front camera(s) of the extended-reality device 130. The process 500 may be implemented using the autocomplete system 640 in FIG. 6. The process 500 may obtain a question 540 being displayed to a user and a plurality of known answers 550, correct or incorrect, that a user likely will enter in response to the question 540. Words 545 and 555 may be extracted respectively from the question 540 and the known answers 550. The extracted words 545 and 555 may be stored in a library 530. The library 530 may correspond to the autocomplete contextual library 650 of FIG. 6. These words represent a finite pool of words that the user is likely to enter in response to the question 540. The process 500 may receive a plurality of captured characters 510 (e.g., 510a, 510b, 510c), where the characters are captured by tracing the shape of the user's hand gesture using the extended-reality device 130. The process 500 may compare the captured characters with the extracted words in the library 530 to make informed guesses for each word in the sentence that forms the answer to the question 540. For each word, the process 500 may make one or more such guesses. The guessed words 560 (e.g., 560a, 560b) may be ranked for each position of the intended answer sentence. The process 500 may then use a speller or grammar checker 520 to identify the most likely words for each position in the sentence and eventually form the answer sentence.

FIG. 6 illustrates an example interface for presenting recall content to a user and capturing an answer to the recall content based on gesture-based character tracing. FIG. 6 illustrates the hand gesture autocomplete answer capture mode, which enables the capture of answers provided by the user by tracing hand-gesture writings by the user as captured by the embedded front camera(s) of the extended-reality device 130. The extended-reality device 130 may present a user interface 610 associated with the extend-reality recall application 132 to the user. The user interface 610 may be presented in a virtual field of view of the user. The user interface 610 may include an indication of answer capture mode 611, a type of question 612, a button for moving to the next question 613 indicating the number of the next question, an identifier of the user 614, a timer 615 (e.g., a count-down timer constraining the time available for entering the answer), recall content (i.e., a question) 616, an answer field 617, and a digital watermark 618. For example, the question may be an open-ended question and the answer capture mode may be set to “Hand Gesture Autocomplete” mode. The extended-reality recall application 132 may have received, and decrypted if needed, the question 616 from the extended-reality recall system 120 and rendered it in the user interface 610. The other components of the user interface 610 may have similar functionalities as corresponding components of the user interface 310 in FIG. 3.

The extended-reality device 130 may capture one or more real-time gestures 620 of the user's hand(s) or finger(s), virtually tracing characters into thin air in a live scene 630 (e.g., a physical environment). To facilitate the virtual writing of words using gesture, the extended-reality recall application 132 applies a process of autocomplete, also known as predictive text, to the first captured couple of characters, using a method developed for word processing and other applications, but applied to a completely different environment. The autocomplete process may be performed by an autocomplete system 640 based on data in an autocomplete contextual library 650. An example of such an autocomplete process is described with respect to FIG. 5. The autocomplete system 640 and the autocomplete contextual library 650 may be implemented as part of the extended-reality recall application 132, the captured content processing system 128, or a combination thereof. To the extent the autocomplete process is at least partially performed on the client side using the extended-reality recall application 132, the recognized answer is sent to the extended-reality recall system 120. To the extend the autocomplete process is at least partially performed on the server side using the captured content processing system 128, the answer is sent to the extended-reality device 130 for rendering.

In some embodiments, to provide visualization feedback to the user, the outline of the tip of the user's finger used for virtual writing is tracked in real-time within the virtual field of view provided by the extended-reality device 130 and stylized as a virtual cursor on top of the rendering of question 616 and the answer field 617. As a character gets recognized by the extended-reality recall application 132, that character gets redrawn using a particular font type and rendered into the answer field 617. As a second character gets added to the first one, the autocomplete algorithm may attempt to extract at least one word from a pool of likely words, starting with these 2 characters, with the extracted word rendered next to the set of captured characters. If no word gets extracted at that time, the autocomplete process may wait for another character to get captured. During the character capture process, the user may visualize each rendered character to be able to correct potentially mistyped characters which would have been incorrectly identified. The extended-reality recall application 132 may further provide one or more interactive elements in the virtual field of view allowing the user to correct any mistyped characters. In the example of FIG. 6, a set of 3 hand gestures with 5 characters successfully captured translates into 3 words in a sentence, which get automatically rendered as part of the answer 617.

The virtual drawing of virtual characters by one or more fingers can be done without any physical support (e.g., in the air facing the embedded camera(s) of the extended-reality device 130) or using any physical medium such as a wall, table, floor or any other surface which the embedded camera(s) can focus on. The display of the question 616 in the user's virtual field of view and the capture of the answer in a physical environment improves content security and prevents potential unauthorized copying or sharing of the recall content.

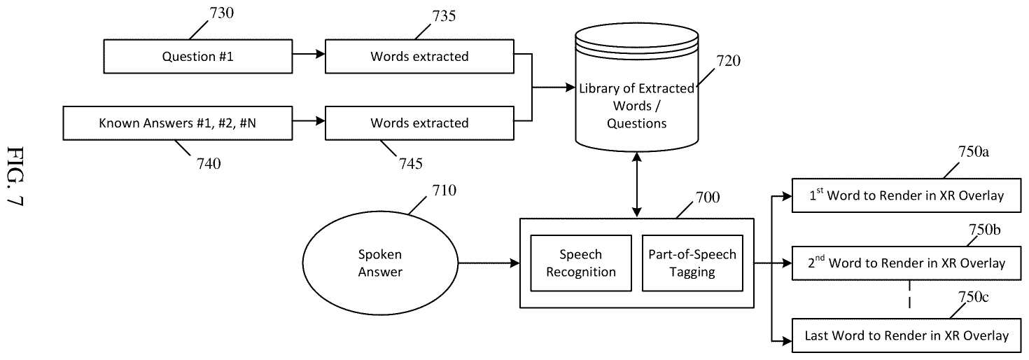

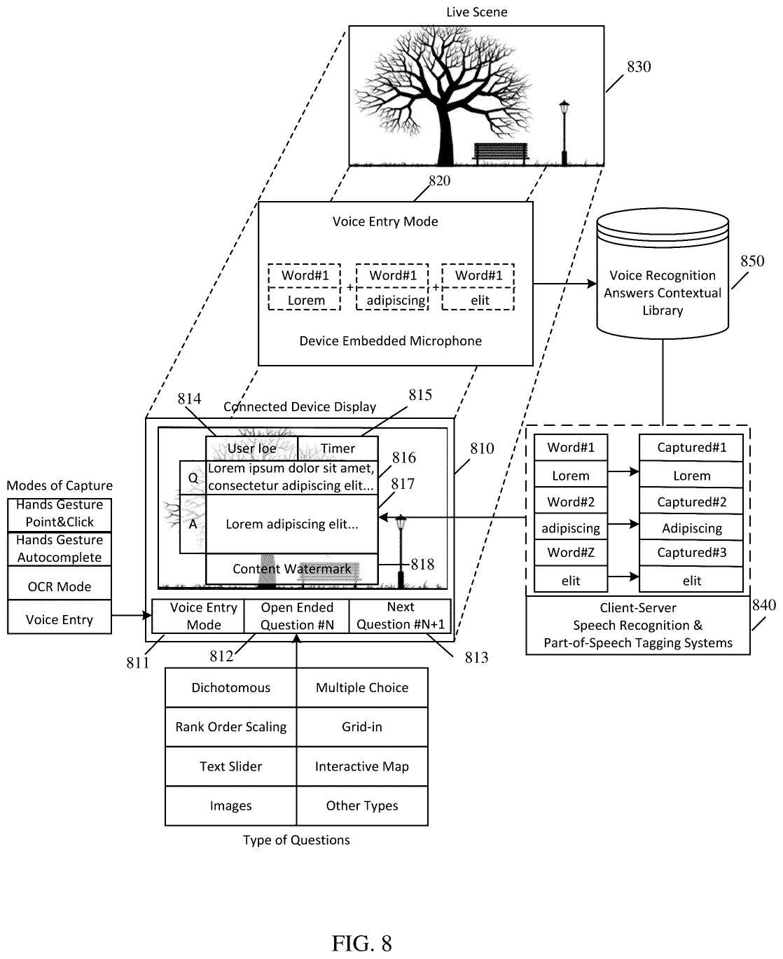

FIG. 7 illustrates an example speech recognition process for capturing an answer. The process 700 may correspond to a voice entry answer capture mode, which enables the capture of answers provided by the user using voice entry processed from the embedded microphone of the extended-reality device 130. The process 700 may be implemented using the speech recognition and part-of-speech tagging system 840 in FIG. 8. In some embodiments, the speech recognition and part-of-speech tagging system 840 may use Hidden Markov model, Viterbi algorithm or other suitable algorithms to disambiguate parts-of-speech, by counting transition and emit counts to estimate probabilities of word data extraction. The speech recognition and part-of-speech tagging system 840 may also use sequence tagging to extract the 9 main parts of speech in English language such as nouns, verbs, adjectives, preposition, pronoun, adverb, conjunction, and interjection. There are typically from 50 to 150 separate parts of speech in parts-of-speech tagging by computer. There are publicly available training data for many languages. Based on the speech analysis, the speech recognition and part-of-speech tagging system 840 may output text content.

The process 700 may enhance the speech recognition process with information about the question and potential answers. The process 700 may obtain a question 730 being displayed to a user and a plurality of known answers 740, correct or incorrect, that a user likely will enter in response to the question 730. Words 735 and 745 may be extracted respectively from the question 730 and the known answers 740. The extracted words 735 and 745 may be stored in a library 720. The library 720 may correspond to the voice recognition answers contextual library 850 of FIG. 8. These words represent a finite pool of words that the user is likely to say in response to the question 730. The process 700 may receive a recording of a spoken answer 710. The process 700 may perform speech recognition and part-of-speech tagging on the spoken answer in light of the library of extracted words to generate multiple words 750 (e.g., 750a, 750b, 750c) as the answer.

FIG. 8 illustrates an example interface for presenting recall content to a user and capturing an answer to the recall content based on audio input. FIG. 8 illustrates the voice entry answer capture mode, which enables the capture of answers provided by the user using voice entry processed from the embedded microphone of the extended-reality device 130. The extended-reality device 130 may present a user interface 810 associated with the extend-reality recall application 132 to the user. The user interface 810 may be presented in a virtual field of view of the user. The user interface 810 may include an indication of answer capture mode 811, a type of question 812, a button for moving to the next question 813 indicating the number of the next question, an identifier of the user 814, a timer 815 (e.g., a count-down timer constraining the time available for entering the answer), recall content (i.e., a question) 816, an answer field 817, and a digital watermark 818. For example, the question may be an open-ended question and the answer capture mode may be set to “Voice Entry” mode. The extended-reality recall application 132 may have received, and decrypted if needed, the question 816 from the extended-reality recall system 120 and rendered it in the user interface 810. The other components of the user interface 810 may have similar functionalities as corresponding components of the user interface 310 in FIG. 3.

The “Voice Entry” mode enables the user to formulate the answer to a written question 816 by using voice as captured by the embedded microphone of the extended-reality device 130. To provide visualization feedback to the user, the extended-reality recall application 132 may render each of the spoken words into the user interface 810 as they get extracted using speech recognition and converted back into text using part-of-speech tagging by the speech-recognition and part-of-speech tagging system 840. The processes by the speech-recognition and part-of-speech tagging system 840 may be based on and with reference to extracted words stored in the voice recognition answers contextual library 850. An example of the speech recognition process is described with respect to FIG. 7. The speech-recognition and part-of-speech tagging system 840 and the voice recognition answers contextual library 850 may be implemented as part of the extended-reality recall application 132, the captured content processing system 128, or a combination thereof. To the extent the speech recognition is at least partially performed on the client side using the extended-reality recall application 132, the recognized answer is sent to the extended-reality recall system 120. To the extend the speech recognition is at least partially performed on the server side using the captured content processing system 128, the answer is sent to the extended-reality device 130 for rendering.

Here, again, the question 816 are decoupled from the user answer 817 because the former is presented in the user's virtual field of view and the latter is spoken by the user in the physical environment. This limits the unauthorized copying and sharing of the recall content between users. The addition of a watermark blends content element of the real and virtual worlds to further protect the content.

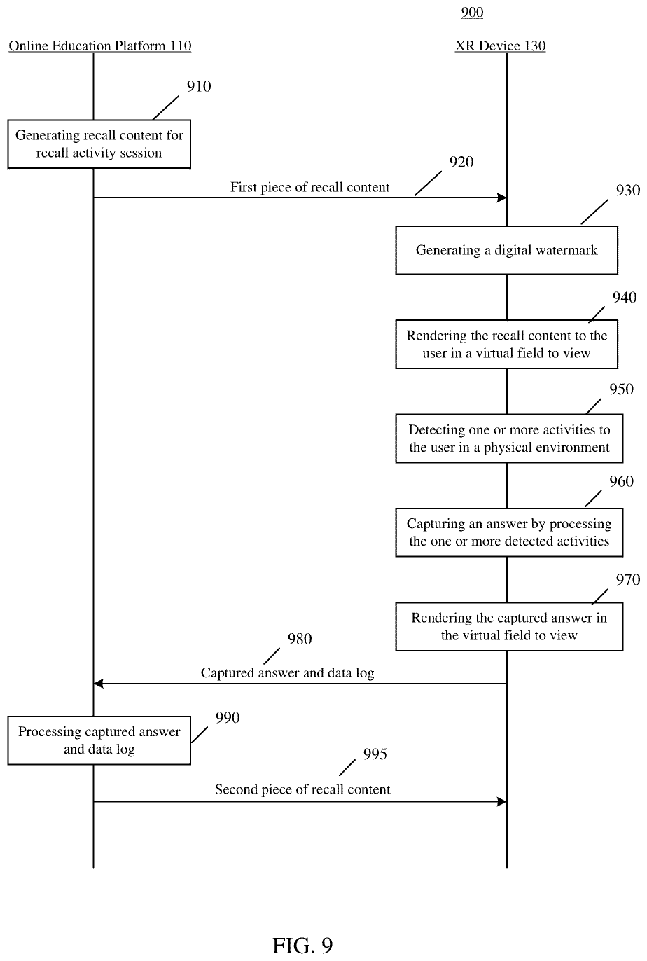

FIG. 9 illustrates an example process 900 for managing recall activities using a server-client system. The process 900 is implemented on the online education platform 110 and the extended-reality device 130. Depending on the implementation, the process 900 may include additional, fewer, or alternative steps performed in various orders or in parallel.

The process 900 may begin at step 910, at which the online education platform 110 may generate recall content for a recall activity session associated with the user. In this embodiment the extended-reality recall system 120 may be implemented as part of the online education platform 110. The recall content may be generated by the extended-reality recall system 120. The recall content for a particular recall activity session may be divided into multiple pieces. Each piece may correspond to, for example, a question of test. At step 920, the online education platform 110 may send a first piece of the recall content to the extended-reality device 130.

At step 930, the extended-reality device 130 may generate a digital watermark based on information associated with the recall activity session and media content captured by one or more sensors (e.g., a front camera) of the extended-reality device 130. At step 940, the extended-reality device 130 may render the recall content to the user in a virtual field of view, where the recall content is embedded with the digital watermark. At step 950, the extended-reality device 130 may detect one or more activities of the user in a physical environment. At step 960, the extended-reality device 130 may capture an answer by processing the one or more activities of the user such as according to one of the answer capture modes described above. At step 970, the extended-reality device may render the captured answer in the virtual field of view for the user to review.

At step 980, the extended-reality device 130 may send data associated with the captured answer to the online education platform 110. The data may include, for example, the text of the captured answer, raw data associated with the detected user activities, and a real-time data log regarding the user's answering of the question(s) in the first piece of recall content. At step 990, the online education platform 110 may process the data received from the extended-reality device 130. For example, the online education platform 110 may determine the answer to a question based on the received data, automatically validate the answer to determine if it is correct and record the answer for further human review. The online education platform 110 may process the data log to determine whether any improper activity occurred during the user's answering of the question (e.g., academic misconduct activities). At step 995, the online education platform 110 may send a second piece of recall content to the extended-reality device 130. The sending of the second piece of recall content may be conditioned on, for example, successful receipt of the answer responding to the first piece of recall content or no detection of improper activity when the user answered the questions in the first piece of recall content. The process 900 may proceed in a similar manner with each piece of recall content until the end of the recall activity session.

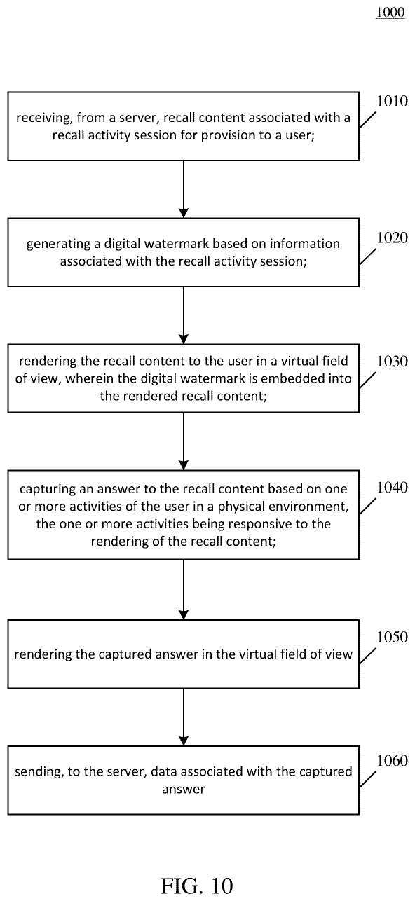

FIG. 10 illustrates an example method 1000 for managing recall activities. The method 1000 may be performed by a device, apparatus, or system for managing recall activities. The method 1000 may be performed by one or more components of the network environment or system illustrated by FIG. 1, such as one or more components of the extended-reality device 130. Depending on the implementation, the method 1000 may include additional, fewer, or alternative steps performed in various orders or in parallel.

Block 1010 includes receiving, from a server, recall content associated with a recall activity session for provision to a user. In some embodiments, the recall activity session is associated with a plurality of pieces of recall content. The receiving the recall content comprises receiving a first piece of recall content, wherein the first piece of recall content is encrypted by a first set of digital rights management (DRM) credentials. The method further comprises receiving, from the server, a second piece of recall content associated with the recall activity session, wherein the second piece of recall content is encrypted by a second set of DRM credentials.

Block 1020 includes generating a digital watermark based on information associated with the recall activity session.

Block 1030 includes rendering the recall content to the user in a virtual field of view. The digital watermark is embedded into the rendered recall content. In some embodiments, the digital watermark comprises one or more of identification information of the recall content, ownership information of the recall content, identification information of the user, time information of the recall activity session, and identification information of the extended-reality system. In some embodiments, the method comprises determining whether to render the recall content constructively or destructively based on the selected input method. The rendering the recall content to the user in a virtual field of view comprises rendering the recall content constructively to overlay on a visual representation of the physical environment or rendering the recall content destructively to mask at least part of the visual representation of the physical environment.

Block 1040 includes capturing an answer to the recall content based on one or more activities of the user in a physical environment. The one or more activities are responsive to the rendering of the recall content. In some embodiments, the method includes automatically selecting an input method based on a type of question associated with the recall content. wherein the capturing the answer comprises analyzing the one or more activities of the user based on the selected input method.

In some embodiments, the capturing an answer to the recall content comprises capturing one or more images of the user writing on a physical or digital medium in the physical environment, performing automatic pattern recognition on the one or more images to determine content written by the user, and setting the answer as the content written by the user. In some embodiments, the capturing an answer to the recall content comprises capturing one or more images of a hand gesture of the user in the physical environment, determining a location in the virtual field of view that corresponds to the hand gesture of the user in the one or more captured images, and determining the answer based on the determined location and the hand gesture of the user. In some embodiments, the capturing an answer to the recall content comprises capturing one or more images of the user's hand gestures in the physical environment, determining one or more characters traced by the user by tracking movement of the user's hand gestures based on the one or more images, generating, using an autocomplete algorithm, one or more words based on the one or more determined characters, and generating the answer as including the one or more generated words. In some embodiments, the capturing an answer to the recall content comprises capturing an audio record of the user speaking and determining the answer by processing the audio record using a speech-recognition algorithm.

Block 1050 includes rendering the captured answer in the virtual field of view.

Block 1060 includes sending, to the server, data associated with the captured answer. In some embodiments, the data associated with the captured answer comprise content of the captured answer and a real-time data log associated with the captured answer.

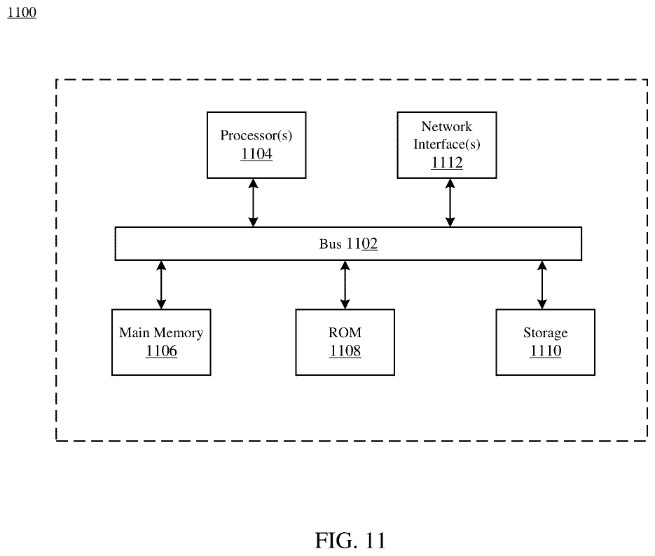

FIG. 11 illustrates a block diagram of an example computer system 1100 in which any of the embodiments described herein may be implemented. The system 1100 may be implemented in any of the components of the environments or systems illustrated in FIG. 1. The software applications, services, and processes illustrated in FIGS. 1-10 may be implemented and operated on the system 1100.

The components of the computer system 1100 may include any suitable physical form, configuration, number, type and/or layout. As an example, and not by way of limitation, the computer system 1100 may include an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 1100 may include one or more computer systems; be unitary or distributed; span multiple locations; span multiple machines; or reside in a cloud, which may include one or more cloud components in one or more networks.

In the depicted embodiment, the computer system 1100 includes a bus 1102, hardware processors 1104, main memory 1106, read only memory (ROM) 1108, storage device 1110 and network interface 1112. Although a particular computer system is depicted having a particular number of particular components in a particular arrangement, this disclosure contemplates any suitable computer system having any suitable number of any suitable components in any suitable arrangement.

The computer system 1100 can include a bus 1102 or other communication mechanism for communicating information, one or more hardware processors 1104 coupled with the bus 1102 for processing information. Bus 1102 may include any combination of hardware, software embedded in a computer readable medium and/or encoded logic incorporated in hardware or otherwise stored (e.g., firmware) to couple components of the computer system 1100 to each other. As an example, and not by way of limitation, bus 1102 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 1102 may include any number, type and/or configuration of buses 1102, where appropriate. In some embodiments, one or more buses 1102 (which may each include an address bus and a data bus) may couple hardware processor(s) 1104 to main memory 1106. Bus 1102 may include one or more memory buses.

The hardware processor(s) 1104 may be, for example, one or more general purpose microprocessors, controller, or any other suitable computing device, resource, or combination of hardware, software and/or encoded logic operable to execute, either alone or in conjunction with other components. Such functionality may include providing various features discussed herein. In some embodiments, hardware processor(s) 1104 may include hardware for executing instructions. As an example, and not by way of limitation, to execute instructions, processor 1104 may retrieve (or fetch) instructions from an internal register, an internal cache, memory 1106, or storage 1110; decode and execute them; and then write one or more results to an internal register, an internal cache, memory 1106, or storage 1110.

In some embodiments, hardware processor(s) 1104 may include one or more internal caches for data, instructions, or addresses. This disclosure contemplates hardware processor(s) 1104 including any suitable number of any suitable internal caches, where appropriate. As an example, and not by way of limitation, hardware processor(s) 1104 may include one or more instruction caches, one or more data caches and one or more translation lookaside buffers (TLBs). Instructions in the instruction caches may be copies of instructions in main memory 1106 or storage device 1110 and the instruction caches may speed up retrieval of those instructions by hardware processor(s) 1104. Data in the data caches may be copies of data in main memory 1106 or storage device 1110 for instructions executing at hardware processor(s) 1104 to operate on; the results of previous instructions executed at hardware processor(s) 1104 for access by subsequent instructions executing at hardware processor(s) 1104, or for writing to main memory 1106, or storage device 1110; or other suitable data. The data caches may speed up read or write operations by hardware processor(s) 1104. The TLBs may speed up virtual-address translations for hardware processor(s) 1104. In some embodiments, hardware processor(s) 1104 may include one or more internal registers for data, instructions, or addresses. Depending on the embodiment, hardware processor(s) 1104 may include any suitable number of any suitable internal registers, where appropriate. Where appropriate, hardware processor(s) 1104 may include one or more arithmetic logic units (ALUs); be a multi-core processor; include one or more hardware processor(s) 1104; or any other suitable processor.

The computer system 1100 can also include a main memory 1106, such as a random access memory (RAM), cache and/or other dynamic storage devices, coupled to the bus 1102 for storing information and instructions to be executed by the hardware processor(s) 1104. The main memory 1106 may also be used for storing temporary variables or other intermediate information during execution of instructions by the hardware processor(s) 1104. Such instructions, when stored in a storage media accessible to the hardware processor(s) 1104, render the computer system 1100 into a special-purpose machine that can be customized to perform the operations specified in the instructions.

In some embodiments, main memory 1106 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Main memory 1106 may include one or more memories 1106, where appropriate. Main memory 1106 may store any suitable data or information utilized by the computer system 1100, including software embedded in a computer readable medium and/or encoded logic incorporated in hardware or otherwise stored (e.g., firmware). In some embodiments, main memory 1106 may include main memory for storing instructions for hardware processor(s) 1104 to execute or data for hardware processor(s) 1104 to operate on. In some embodiments, one or more memory management units (MMUs) may reside between hardware processor(s) 1104 and main memory 1106 and facilitate accesses to main memory 1106 requested by hardware processor(s) 1104.

The computer system 1100 can further include a read only memory (ROM) 1108 or other static storage device coupled to the bus 1102 for storing static information and instructions for the hardware processor(s) 1104. A storage device 1110, such as a magnetic disk, optical disk, or USB thumb drive (Flash drive), etc., can be provided and coupled to the bus 1102 for storing information and instructions.

As an example, and not by way of limitation, the computer system 1100 may load instructions from storage device 1110 or another source (such as, for example, another computer system) to main memory 1106. Hardware processor(s) 1104 may then load the instructions from main memory 1106 to an internal register or internal cache. To execute the instructions, hardware processor(s) 1104 may retrieve the instructions from the internal register or internal cache and decode them. During or after execution of the instructions, hardware processor(s) 1104 may write one or more results (which may be intermediate or final results) to the internal register or internal cache. Hardware processor(s) 1104 may then write one or more of those results to main memory 1106. In some embodiments, hardware processor(s) 1104 may execute only instructions in one or more internal registers or internal caches or in main memory 1106 (as opposed to storage device 1110 or elsewhere) and may operate only on data in one or more internal registers or internal caches or in main memory 1106 (as opposed to storage device 1110 or elsewhere).

In some embodiments, storage device 1110 may include mass storage for data or instructions. As an example, and not by way of limitation, storage device 1110 may include a hard disk drive (HDD), a floppy disk drive, flash memory, an optical disc, a magneto-optical disc, magnetic tape, or a Universal Serial Bus (USB) drive or a combination of two or more of these. Storage device 1110 may include removable or non-removable (or fixed) media, where appropriate. Storage device 1110 may be internal or external to the computer system 1100, where appropriate. In some embodiments, storage device 1110 may be non-volatile, solid-state memory. In some embodiments, storage device 1110 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage device 1110 may take any suitable physical form and may include any suitable number or type of storage. Storage device 1110 may include one or more storage control units facilitating communication between hardware processor(s) 1104 and storage device 1110, where appropriate.

Computer system 1100 can further include at least one network interface 1112. In some embodiments, network interface 1112 may include hardware, encoded software, or both providing one or more interfaces for communication (such as, for example, packet-based communication) among any networks, any network devices and/or any other computer systems. As an example, and not by way of limitation, network interface 1112 may include a network interface controller (NIC), network adapter, or the like, or a combination thereof, coupled to the bus 1102 for communicating the computer system 1100 to at least one network with an Ethernet or other wire-based network and/or a wireless NIC (WNIC) or wireless adapter for communicating with a wireless network.

Depending on the embodiment, network interface 1112 may be any type of interface suitable for any type of network for which computer system 1100 is used. As an example, and not by way of limitation, computer system 1100 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 1100 may include any suitable network interface 1112 for any one or more of these networks, where appropriate.

In some embodiments, network interface 1112 may include one or more interfaces for one or more I/O devices. One or more of these I/O devices may enable communication between a person and the computer system 1100. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Some embodiments may include any suitable type and/or number of I/O devices and any suitable type and/or number of network interface 1112 for them. Where appropriate, may include one or more drivers enabling hardware processor(s) 1104 to drive one or more of these I/O devices. Network interface 1112 may include one or more network interface 1112, where appropriate.

In general, the word “component,” “modules,” “engine,” “system,” “database,” and the like, as used herein, can refer to logic embodied in hardware or firmware, or to a collection of software instructions, possibly having entry and exit points, written in a programming language, such as, for example, Java, C or C++. A software component or module may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices, such as the computing system 1100, may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of an executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques or technology described herein using customized hard-wired logic, one or more ASICs or FPGAs, firmware and/or program logic which in combination with the computer system 1100 that causes or programs the computer system 1100 to be a special-purpose machine. According to one or more examples, the techniques described herein are performed by the computer system 1100 in response to the hardware processor(s) 1104 executing one or more sequences of one or more instructions contained in the main memory 1106. Such instructions may be read into the main memory 1106 from another storage medium, such as the storage device 1110. Execution of the sequences of instructions contained in the main memory 1106 can cause the hardware processor(s) 1104 to perform process steps described herein. In alternative examples, hard-wired circuitry may be used in place of or in combination with software instructions.

Herein, reference to a computer-readable storage medium encompasses one or more tangible computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Some embodiments may include one or more computer-readable storage media implementing any suitable storage. In some embodiments, a computer-readable storage medium implements one or more portions of hardware processor(s) 1104 (such as, for example, one or more internal registers or caches), one or more portions of memory 620, one or more portions of storage device 1110, or a combination of these, where appropriate. In some embodiments, a computer-readable storage medium implements RAM or ROM. In some embodiments, a computer-readable storage medium implements volatile or persistent memory. In some embodiments, one or more computer-readable storage media embody encoded software.

The term “non-transitory media,” and similar terms, as used herein refers to any media that store data and/or instructions that cause a machine to operate in a specific fashion. Such non-transitory media may comprise non-volatile media and/or volatile media. The non-volatile media can include, for example, optical or magnetic disks, such as the storage device 1110. The volatile media can include dynamic memory, such as the main memory 1106. Common forms of the non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The non-transitory media is distinct from but may be used in conjunction with transmission media. The transmission media can participate in transferring information between the non-transitory media. For example, the transmission media can include coaxial cables, copper wire and fiber optics, including the wires that comprise the bus 1102. The transmission media can also take a form of acoustic or light waves, such as those generated during radio-wave and infra-red data communications.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In some embodiments, encoded software includes one or more application programming interfaces (APIs) stored or encoded in a computer-readable storage medium. Some embodiments may use any suitable encoded software written or otherwise expressed in any suitable programming language or combination of programming languages stored or encoded in any suitable type or number of computer-readable storage media. In some embodiments, encoded software may be expressed as source code or object code. In some embodiments, encoded software is expressed in a higher-level programming language, such as, for example C, Perl, or a suitable extension thereof. In some embodiments, encoded software is expressed in a lower-level programming language, such as assembly language (or machine code). In some embodiments, encoded software is expressed in JAVA. In some embodiments, encoded software is expressed in Hyper Text Markup Language (HTML), Extensible Markup Language (XML), or other suitable markup language. The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in some embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in some embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

As used herein, the term “or” may be construed in either an inclusive or exclusive sense. Moreover, the description of resources, operations, or structures in the singular shall not be read to exclude the plural. Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to some embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

1. An extended-reality system for managing recall activities, comprising one or more processors and a non-transitory computer readable medium storing instructions that, when executed by the one or more processors, cause the system to perform operations comprising:
receiving, from a server, recall content associated with a recall activity session for provision to a user;
generating a digital watermark based on information associated with the recall activity session;
rendering the recall content to the user in a virtual field of view, wherein the digital watermark is embedded into the rendered recall content;
capturing an answer to the recall content based on one or more activities of the user in a physical environment, the one or more activities being responsive to the rendering of the recall content;
rendering the captured answer in the virtual field of view; and
sending, to the server, data associated with the captured answer.

2. The system of claim 1, wherein the capturing an answer to the recall content comprises:
capturing one or more images of the user writing on a physical or digital medium in the physical environment;
performing automatic pattern recognition on the one or more images to determine content written by the user; and
setting the answer as the content written by the user.

3. The system of claim 1, wherein the capturing an answer to the recall content comprises:
capturing one or more images of a hand gesture of the user in the physical environment;
determining a location in the virtual field of view that corresponds to the hand gesture of the user in the one or more captured images; and
determining the answer based on the determined location and the hand gesture of the user.

4. The system of claim 1, wherein the capturing an answer to the recall content comprises:
capturing one or more images of the user's hand gestures in the physical environment;
determining one or more characters traced by the user by tracking movement of the user's hand gestures based on the one or more images;
generating, using an autocomplete algorithm, one or more words based on the one or more determined characters; and
generating the answer as including the one or more generated words.

5. The system of claim 1, wherein the capturing an answer to the recall content comprises:
capturing an audio record of the user speaking; and
determining the answer by processing the audio record using a speech-recognition algorithm.

6. The system of claim 1, wherein the digital watermark comprises one or more of:
identification information of the recall content;
ownership information of the recall content;
identification information of the user;
time information of the recall activity session;
identification information of the extended-reality system; or
media captured from the physical environment.

7. The system of claim 1, wherein the operations further comprise:
automatically selecting an input method based on a type of question associated with the recall content, wherein the capturing the answer comprises analyzing the one or more activities of the user based on the selected input method.

8. The system of claim 7, wherein:
the rendering the recall content to the user in a virtual field of view comprises rendering the recall content constructively to overlay on a visual representation of the physical environment or rendering the recall content destructively to mask at least part of the visual representation of the physical environment; and
the operations further comprise determining whether to render the recall content constructively or destructively based on the selected input method.

9. The system of claim 1, wherein:
the recall activity session is associated with a plurality of pieces of recall content;
the receiving the recall content comprises receiving a first piece of recall content, wherein the first piece of recall content is encrypted by a first set of digital rights management (DRM) credentials; and
the operations further comprise receiving, from the server, a second piece of recall content associated with the recall activity session, wherein the second piece of recall content is encrypted by a second set of DRM credentials.

10. The system of claim 1, wherein the data associated with the captured answer comprise:
content of the captured answer; and
a real-time data log associated with the captured answer.

11. A method for managing recall activities implemented on an extended-reality device, comprising:
receiving, from a server, recall content associated with a recall activity session for provision to a user;
generating a digital watermark based on information associated with the recall activity session;
rendering the recall content to the user in a virtual field of view, wherein the digital watermark is embedded into the rendered recall content;
capturing an answer to the recall content based on one or more activities of the user in a physical environment, the one or more activities being responsive to the rendering of the recall content;
rendering the captured answer in the virtual field of view; and
sending, to the server, data associated with the captured answer.

12. The method of claim 11, wherein the capturing an answer to the recall content comprises:
capturing one or more images of the user writing on a physical or digital medium in the physical environment;
performing automatic pattern recognition on the one or more images to determine content written by the user; and
setting the answer as the content written by the user.

13. The method of claim 11, wherein the capturing an answer to the recall content comprises:
capturing one or more images of a hand gesture of the user in the physical environment;
determining a location in the virtual field of view that corresponds to the hand gesture of the user in the one or more captured images; and
determining the answer based on the determined location and the hand gesture of the user.

14. The method of claim 11, wherein the capturing an answer to the recall content comprises:
capturing one or more images of the user's hand gestures in the physical environment;
determining one or more characters traced by the user by tracking movement of the user's hand gestures based on the one or more images;
generating, using an autocomplete algorithm, one or more words based on the one or more determined characters; and
generating the answer as including the one or more generated words.

15. The method of claim 11, wherein the capturing an answer to the recall content comprises:
capturing an audio record of the user speaking; and
determining the answer by processing the audio record using a speech-recognition algorithm.

16. The method of claim 11, wherein the digital watermark comprises one or more of:
identification information of the recall content;
ownership information of the recall content;
identification information of the user;
time information of the recall activity session;
identification information of the extended-reality system; or
media captured from the physical environment.

17. The method of claim 11, further comprising:
automatically selecting an input method based on a type of question associated with the recall content, wherein the capturing the answer comprises analyzing the one or more activities of the user based on the selected input method.

18. The method of claim 17, wherein:
the rendering the recall content to the user in a virtual field of view comprises rendering the recall content constructively to overlay on a visual representation of the physical environment or rendering the recall content destructively to mask at least part of the visual representation of the physical environment; and
the method further comprises determining whether to render the recall content constructively or destructively based on the selected input method.

19. The method of claim 11, wherein:
the recall activity session is associated with a plurality of pieces of recall content;
the receiving the recall content comprises receiving a first piece of recall content, wherein the first piece of recall content is encrypted by a first set of digital rights management (DRM) credentials; and
the method further comprises receiving, from the server, a second piece of recall content associated with the recall activity session, wherein the second piece of recall content is encrypted by a second set of DRM credentials.

20. A non-transitory computer-readable storage medium associated with an extended-reality device for managing recall activities, configured with instructions executable by one or more processors to cause the one or more processors to perform operations comprising:
receiving, from a server, recall content associated with a recall activity session for provision to a user;
generating a digital watermark based on information associated with the recall activity session;
rendering the recall content to the user in a virtual field of view, wherein the digital watermark is embedded into the rendered recall content;
capturing an answer to the recall content based on one or more activities of the user in a physical environment, the one or more activities being responsive to the rendering of the recall content;
rendering the captured answer in the virtual field of view; and
sending, to the server, data associated with the captured answer.
